(19) United States
(12) Patent Application Publication
(10) Pub. No.: US 2026/0244803 A1
(43) Pub. Date: Aug. 20, 2026

(54) METHOD FOR DESIGNING CONSTRUCTION PARAMETERS OF NITROGEN FOAM-CARRIED GRAVEL PACKING IN HIGH-LOSS HORIZONTAL WELLS

(71) Applicant: China University of Petroleum (East China), Dongying (CN)

(72) Inventors: Changyin DONG, Dongying (CN); Guolong LI, Dongying (CN); Dongyu XUE, Dongying (CN); Youchuang LIU, Dongying (CN); Jinyi ZHANG, Dongying (CN); Haoyu WANG, Dongying (CN); Li BAI, Dongying (CN)

(73) Assignee: China University of Petroleum (East China), Dongying (CN)

(21) Appl. No.: 19/328,041

(22) Filed: Sep. 12, 2025

(30) Foreign Application Priority Data
Feb. 17, 2025 (CN) 2025101726502

(51) Int. Cl. G06F 30/13; C09K 8/506; C09K 8/518; E21B 41/00; E21B 43/04; E21B 47/07; E21B 47/10; E21B 49/00; G06F 111/10

(52) U.S. Cl. CPC G06F 30/13; C09K 8/506; C09K 8/518; E21B 41/00; E21B 43/04; E21B 47/07; E21B 47/10; E21B 49/00; G06F 2111/10

(57) ABSTRACT

Disclosed is a method for designing construction parameters of nitrogen foam-carried gravel packing in high-loss horizontal wells in the technical field of oil and gas exploitation engineering, including: S1: determining a nitrogen foam gas-liquid ratio G_{wr} and a foaming agent concentration C_{f} for the nitrogen foam-carried gravel packing in the horizontal wells using a reservoir fluid loss rate Rₗ and a packing safety index Fₛ; S2: calculating an apparent density ρ_{f} and apparent viscosity μ_{f} of a nitrogen foam fluid in a washpipe-screen annulus under downhole temperature and pressure conditions; S3: calculating a pumping rate and sand ratio for construction operations based on the apparent density and apparent viscosity of the nitrogen foam fluid under the downhole temperature and pressure conditions.

### CROSS-REFERENCE TO RELATED APPLICATIONS

The application claims priority to Chinese patent application No. 2025101726502, filed on Feb. 17, 2025, the entire contents of which are incorporated herein by reference.

### TECHNICAL FIELD

This disclosure relates to the technical field of oil and gas exploitation engineering, and in particular, to a method for designing construction parameters of nitrogen foam-carried gravel packing in high-loss horizontal wells.

### BACKGROUND

Unconsolidated sandstone reservoirs are widely distributed in China and worldwide, holding significant reserves and production potential. However, due to their loosely cemented nature, sand production often occurs during exploitation, necessitating effective sand control measures. Horizontal wells are one of the primary well types for developing such reservoirs, with gravel packing being a common sand control technique. As oilfields enter mid-to-late development stages, formation pressure gradually declines, exacerbating sand production. This leads to high carrier fluid loss into the formation during gravel packing operations in horizontal wells, further causing the deposited sand bed to lift. Such conditions easily trigger premature sand bridging, which may ultimately result in operational failure.

Nitrogen foam-carried gravel packing fluid is a dispersed system formed by an insoluble or slightly soluble gas dispersed in a liquid or solid-liquid mixed fluid, classified as a compressible non-Newtonian fluid. Low-density foam-carried gravel packing fluid can effectively control hydrostatic and operational pressures, protect the reservoir, and minimize fluid loss. Moreover, foam, as a good transport medium, exhibits superior performance in carrying particles. Currently, nitrogen foam-carried gravel packing technology for horizontal wells has seen pilot applications in high-loss reservoirs and may become a vital well completion means for gravel packing in horizontal wells within medium-to-high permeability reservoirs in the future.

As a sand control technology aimed at reducing fluid loss and achieving efficient packing, nitrogen foam-carried gravel packing in horizontal wells still faces critical challenges: 1) existing design processes are overly cumbersome and complex, with numerical simulation-based optimization designs lacking accuracy; and there is a lack of an optimized method for designing the nitrogen foam gas-liquid ratio and the foaming agent concentration for nitrogen foam-carried gravel packing in horizontal wells, leaving on-site construction operations without a reliable basis for selecting target wells; 2) no rapid prediction method exists for calculating the apparent density and viscosity of nitrogen foam in the washpipe-screen annulus under downhole temperature and pressure conditions based on the gas-liquid ratio and foaming agent concentration; and 3) a simplified and efficient optimized method for designing construction parameters of nitrogen foam-carried gravel packing in horizontal wells is lacking.

### SUMMARY

This disclosure is intended to address the current lack of an optimized method for designing the gas-liquid ratio and the foaming agent concentration and an optimized method for designing construction parameters such as the pumping rate and sand ratio in nitrogen foam-carried gravel packing in horizontal wells within unconsolidated sandstone reservoirs prone to sand production.

This disclosure provides an optimized method for designing the nitrogen foam gas-liquid ratio and the foaming agent concentration for nitrogen foam-carried gravel packing in horizontal wells using simple physical parameters of reservoirs and wellbore parameters, and further provides a rapid prediction method for the apparent density and viscosity of nitrogen foam in the washpipe-screen annulus under downhole temperature and pressure conditions. Furthermore, a simplified and efficient optimized method for designing construction parameters of nitrogen foam-carried gravel packing in horizontal wells is established. This disclosure offers a convenient and operational solution for rapid decision-making in sand control operations using nitrogen foam-carried gravel packing in high-loss horizontal wells within unconsolidated sandstone reservoirs, aiming to enhance sand control efficiency and exploitation performance in fluid-loss wells.

To achieve the aforementioned purpose, this disclosure proposes a method for designing construction parameters of nitrogen foam-carried gravel packing in high-loss horizontal wells, including the following steps:
S1: determining a nitrogen foam gas-liquid ratio G_{wr} and a foaming agent concentration C_{f} for the nitrogen foam-carried gravel packing in the horizontal wells using a reservoir fluid loss rate Ri and a packing safety index Fₛ;
S2: calculating an apparent density p_{f} and apparent viscosity μ_{f} of a nitrogen foam fluid in a washpipe-screen annulus under downhole temperature and pressure conditions; and

S3: calculating a pumping rate and sand ratio for construction operations based on the apparent density and apparent viscosity of the nitrogen foam fluid under the downhole temperature and pressure conditions.

Preferably, in the step S1, an optimized method for designing the nitrogen foam gas-liquid ratio and the foaming agent concentration for the nitrogen foam-carried gravel packing in the horizontal wells is primarily based on basic geological parameters and information of a reservoir and oil well conditions. By calculating the reservoir fluid loss rate Rₗ and the packing safety index Fₛ, these two indicators enable rapid determination of the optimal gas-liquid ratio and foaming agent concentration for the given conditions. The calculation method and process are straightforward and easily implementable.

Preferably, in the step S2, based on the optimal nitrogen foam gas-liquid ratio and foaming agent concentration obtained in the step S1, the apparent density and apparent viscosity of the nitrogen foam fluid in the washpipe-screen annulus under the downhole temperature and pressure conditions are rapidly calculated, enabling scientific and rational design of efficient nitrogen foam-carried gravel packing in horizontal wells.

Preferably, in the step S3, an optimized method for designing the construction parameters for the nitrogen foam-carried gravel packing in the horizontal wells includes: calculating the pumping rate and sand ratio for the construction operations based on the apparent density and apparent viscosity of the nitrogen foam fluid in the washpipe-screen annulus under the downhole temperature and pressure conditions, thereby enabling more accurate on-site determination of the construction parameters.

Preferably, the step S1 includes the following steps:
1) calculating the reservoir fluid loss rate Ri based on basic geological parameters of a reservoir

The reservoir fluid loss rate Ri is generally defined as a ratio of an injected fluid volume to a returned fluid volume during on-site construction. For the high-loss horizontal wells, the fluid loss during construction can reach up to 0.3-0.5. If field data for the reservoir fluid loss rate are unavailable, a simplified calculation method proposed herein may be used to estimate the reservoir fluid loss rate: If Rₗ≤0.1, there is no/minor fluid loss; if 0.1<Rₗ≤0.2, there is minor to moderate fluid loss; if 0.2<Rₗ≤0.35, there is moderate to severe fluid loss; if 0.35<Rₗ, there is severe fluid loss.

$${R}_{l} = \frac{K}{{K}_{0}} \cdot \sqrt{φ \cdot {V}_{s h}} \cdot \frac{{P}_{f 0}}{{P}_{f}} \cdot \frac{{P}_{c} + {ρ}_{r} gh / 1000}{{P}_{f}} \qquad ( 1 )$$

$$where$$

$$\{ \begin{matrix}K = {K}_{0} \cdot ( 1 + \frac{{V}_{c}}{{V}_{r}} ) \\ R {e}_{r} = \frac{{v}_{r} {ρ}_{r} {d}_{c w}}{{μ}_{r}} \\ {P}_{c} = \frac{64}{R {e}_{r}} \cdot \frac{L}{{d}_{c w}} \cdot \frac{{ρ}_{r} {v}_{r}^{2}}{2}\end{matrix} \qquad ( 2 )$$

where Rₗ represents the reservoir fluid loss rate; P_{f0} represents an original reservoir pressure, MPa; P_{f} represents a current reservoir pressure, MPa; P_{c} represents a wellbore construction pressure, MPa; h represents a vertical depth of a horizontal well, m; K₀ represents an original reservoir permeability, D; K represents a current reservoir permeability (which can be calculated based on the original reservoir permeability and a sand production volume), D; V_{c} represents the sand production volume obtained through field detection, m³; Vᵣ represents a formation volume within a 3-m radius around a production zone, m³; φ represents a formation porosity, %; and Vₛₕ represents a reservoir shale content, %; ρᵣ represents a conventional carrier fluid density, kg/m³; vᵣ represents a conventional carrier fluid flow velocity, m/s; L represents a length of a horizontal well section, m; Reᵣ represents a Reynolds number for the horizontal well section; d_{cw} represents an apparent diameter of a washpipe-casing annulus, m; μᵣ represents a conventional carrier fluid viscosity, Pa·s; and g is equal to 9.8 N/kg.
2) Calculating the packing safety index Fₛ based on basic parameters of oil well conditions

The packing safety index Fₛ is used to evaluate a safety level during the gravel packing in the horizontal wells. If Fₛ≤0.4, there is a high risk of sand bridging; if 0.4<Fₛ≤0.9, there is a moderate risk of sand bridging; if 0.9<Fₛ≤1.2, there is a low risk of sand bridging; if Fₛ>1.2, there is a negligible or minimal risk of sand bridging. This index incorporates key parameters affecting sand bridging during the gravel packing in the horizontal wells, including the reservoir fluid loss rate Rₗ, an inclination angle θ of the horizontal well, a length Lₕₗₛ of a well section with fluid loss, a screen-casing ratio R_{sw}, and a washpipe-screen ratio R_{cs}.

$${F}_{s} = 0.25 \times ln ( \frac{L}{{R}_{l} {L}_{hls}} ) + 0.5 \times \frac{{R}_{c s}}{{R}_{s w}} - 0.25 \times \frac{θ}{90} \qquad ( 3 )$$

where Lₕₗₛ represents the length of the well section with fluid loss, m; R_{sw} represents the screen-casing ratio; R_{cs} represents the washpipe-screen ratio; and 0 represents the inclination angle of the horizontal well, °.
3) Calculating the gas-liquid ratio G_{wr} and the foaming agent concentration C_{f} based on the reservoir fluid loss rate Ri and the packing safety index Fₛ

$${G}_{w r} = 1.937 \cdot {R}_{l}^{0.135} \cdot {F}_{s}^{- 0.081} \cdot {T}^{0.005} \qquad ( 4 )$$

where G_{wr} represents the gas-liquid ratio; and T represents a reservoir temperature, ° C.

$$\{ \begin{matrix}{C}_{f} = 1.54 \cdot {R}_{1}^{0.228} \cdot {F}_{S}^{0.096} \cdot {T}^{0.012} ( quartz sand ) \\ {C}_{f} = 1.369 \cdot {R}_{1}^{0.347} \cdot {F}_{S}^{0.099} \cdot {T}^{0.011} ( ceramic proppant )\end{matrix} \qquad ( 5 )$$

where C_{f} represents the foaming agent concentration, %.

Based on experimental simulation results, the design of nitrogen foam gas-liquid ratio and foaming agent injection parameters is optimized, establishing rapid calculation methods for the gas-liquid ratio and the foaming agent concentration. The experimental simulation results are utilized to optimize the design of nitrogen foam gas-liquid ratio and foaming agent injection parameters according to well conditions and fluid loss characteristics. Considering both packing efficiency and economy, the experimental simulation results demonstrate that for quartz sand with a higher density, optimal performance is achieved with a foaming agent concentration of 1.25%-1.75%; and for ceramic proppants with a lower density, optimal performance is achieved with a foaming agent concentration of 1%-1.5%.

The optimal nitrogen foam gas-liquid ratio obtained from nitrogen foam-carried gravel packing experiments was determined to be 1.5 (Note: the gas-liquid ratio here refers to the ratio of nitrogen volume to liquid volume under the downhole temperature and pressure conditions). Considering the differences between experimental and field conditions, a gas-liquid ratio of 1.5-2.25 is recommended. Based on the experimental results, a least squares fitting method is applied to establish rapid calculation methods for the gas-liquid ratio and foaming agent concentration based on three technical indicators, respectively the reservoir temperature T, the packing safety index Fₛ, and the reservoir fluid loss rate Rₗ.

To facilitate field application and implementation, a quick selection table for nitrogen and foaming agent injection parameters is further provided below, enabling rapid optimization design of the nitrogen and foaming agent injection parameters. The parameters can be selected when any two conditions in the same row are satisfied, and the relationship between the indicators follows an “OR” logic.

TABLE 1
Quick Selection of Nitrogen and Foaming
Agent Injection Parameters

| | | | | | Recommended |
|---|---|---|---|---|---|
| Reservoir | Packing | Reservoir | | Recommended | foaming agent |
| fluid loss | safety | temperature | | gas-liquid | concentration |
| rate Rₗ | index Fₛ | T/° C. | | ratio G_{wr} | C_{f}/% |
| Rₗ ≤ 0.1 | 1.2 ≤ Fₛ | <55° | C. | / | / |
| 0.1 < Rₗ ≤ | 0.9 < Fₛ ≤ | 55-60° | C. | 1.5 | Quartz sand 1.25 |
| 0.2 | 1.2 | | | | (ceramic proppant |
| | | | | | 1.0) |
| 0.2 < Rₗ ≤ | 0.4 < Fₛ ≤ | 60-65° | C. | 1.75 | Quartz sand 1.35 |
| 0.35 | 0.9 | | | | (ceramic proppant |
| | | | | | 1.25) |
| 0.35 < | 0.1 < Fₛ ≤ | 65-70 | C. | 2 | Quartz sand 1.5 |
| Rₗ ≤ | 0.4 | | | | (ceramic proppant |
| 0.45 | | | | | 1.35) |
| 0.45 < Rₗ | Fₛ < 0.1 | >70° | C. | 2.25 | Quartz sand 1.75 |
| | | | | | (ceramic proppant |
| | | | | | 1.5) |

Preferably, the step S2 includes the following steps:
2) calculating nitrogen foam quality Γ

$$Γ = 100 \frac{{G}_{wr} - 1}{{G}_{wr}} \qquad ( 6 )$$

where Γ represents the nitrogen foam quality, %.
3) Calculating the density of the nitrogen foam fluid under the downhole temperature and pressure conditions

The nitrogen foam fluid is formulated by mixing a liquid and a gas at a specific ratio, with its density calculated by the following formula:

$${ρ}_{f} = ( 1 - Γ ) {ρ}_{l} + Γ {ρ}_{g} \qquad ( 7 )$$

where ρ_{f} represents the density of the nitrogen foam fluid, kg/m³; ρₗ represents a liquid density, kg/m³; and ρ_{g} represents a nitrogen density under the downhole temperature and pressure conditions, kg/m³, which can be quickly determined according to FIG. 2 for different temperature and pressure conditions.
4) Calculating rheological parameters of a power-law fluid for nitrogen foam under the downhole temperature and pressure conditions

Based on the constitutive equation of power-law fluids and the fundamental rheological equation for pipe flows, the following can be derived:

$$ln {τ}_{w} = ln {K ( \frac{3 n + 1}{4 n} )}^{n} + n ln ( \frac{8 u}{d} ) \qquad ( 8 )$$

$${τ}_{w} = \frac{Δ p d}{4 {L}_{m}}$$

$$γ = \frac{8 u}{d}$$

where γ represents a shear rate, s⁻¹; τ_{w} represents a wall shear stress in a circular capillary tube, N; K represents a consistency coefficient; n represents a flow index; d represents a diameter of the circular capillary tube, m; Lₘ represents a length of the circular capillary tube, m; u represents an average flow velocity in the circular capillary tube, m/s; and ΔP represents a differential pressure across the circular capillary tube, Pa.

The experiments may employ sodium dodecyl benzene sulfonate (SDBS) as a foaming agent commonly used in oilfield operations. Using a capillary rheometer, nitrogen foam rheology experiments are conducted under different temperature, pressure, and nitrogen foam quality conditions; then rheological parameters of a power-law fluid, namely the flow index n and the consistency coefficient K, for nitrogen foam under the different temperature and pressure conditions are determined based on a relationship between a flow rate and a pressure drop during the experiments. The experimental results are listed below.

TABLE 2
Calculation Results of Rheological Parameters of the Power-
Law Fluid under Different Nitrogen Foam Quality Conditions

| Nitrogen foam quality/% | K | n |
|---|---|---|
| 50 | 0.007 | 0.703 |
| 60 | 0.012 | 0.621 |
| 75 | 0.03 | 0.56 |
| 86 | 0.02 | 0.72 |
| 98 | 0.014 | 0.305 |

TABLE 3
Calculation Results of Rheological Parameters of
the Power-Law Fluid under Different Pressure Conditions
(Nitrogen Foam Quality 86%, 70° C.)

| Pressure | K | n |
|---|---|---|
| 0.1 | 0.002 | 0.926 |
| 5 | 0.004 | 0.875 |
| 10 | 0.012 | 0.621 |
| 20 | 0.065 | 0.439 |

TABLE 4
Calculation Results of Rheological Parameters of the
Power-Law Fluid under Different Temperature Conditions
(Nitrogen Foam Quality 86%, Pressure 10 MPa)

| Temperature | K | n |
|---|---|---|
| 25 | 0.099 | 0.386 |
| 50 | 0.04 | 0.528 |
| 70 | 0.012 | 0.621 |
| 100 | 0.0035 | 0.694 |

Normalization processing is performed on the experiments to fit the following calculation formulas for the rheological parameters under different conditions:

$$\{ \begin{matrix}{K}_{1} = - 0.000027 {Γ}^{2} + 0.004166 Γ + - 0.136098 \\ {K}_{2} = 28.075 \cdot {e}^{( - 0.046 t )} \\ {K}_{3} = 0.1589 \cdot {e}^{( 0.1775 p )} \\ {n}_{1} = - 0.000028 {Γ}^{3} + 0.006018 {Γ}^{2} + - 0.422598 Γ + 10.308523 \\ {n}_{2} = 0.3 \; 619 ln ( t ) - 0.5488 \\ {n}_{3} = 1.57 \cdot {e}^{( - 0.04 p )} \\ K = K 1 \cdot K 2 \cdot K 3 \cdot \frac{1.5}{{C}_{f}} \\ n = {n}_{1} \cdot {n}_{2} \cdot {n}_{3}\end{matrix} \qquad ( 9 )$$

The formulas are further simplified as follows:

$$\{ \begin{matrix}K = \frac{6.692}{{C}_{f}} ( - 0.000027 {Γ}^{2} + 0.004166 Γ + - 0.13 \; 6098 ) \cdot {e}^{( 0.1775 p - 0.046 t )} \\ n = 1.57 ( - 0.000028 {Γ}^{3} + 0.006018 {Γ}^{2} + - 0.422598 Γ + 10.308523 ) {e}^{( - 0.04 p )} \cdot ( 0.3619 ln ( t ) - 0.5\end{matrix} \qquad ( 10 )$$

The rheological parameters of the power-law fluid for nitrogen foam under different temperature and pressure conditions can be obtained using the above Formula 10.
5) Calculating the apparent viscosity us of the nitrogen foam fluid in a downhole washpipe-casing annulus

To determine the apparent viscosity of the nitrogen foam fluid in the downhole washpipe-casing annulus (an annular space formed between the washpipe and the casing), the shear rate of the power-law fluid is considered dependent on the flow index n. The apparent diameter of the washpipe-casing annulus is represented by d_{cw}. The shear rate of fluid flow in the washpipe-casing annulus can be expressed by the following formula:

$$γ = \frac{3 n + 1}{4 n} \cdot \frac{8 {u}_{cw}}{{d}_{cw}} \qquad ( 11 )$$

$${d}_{cw} = 4 \frac{π ( {R}_{w}^{2} - {r}_{c}^{2} )}{2 π ( {R}_{w} + {r}_{c} )}$$

The apparent viscosity of the nitrogen foam fluid in the washpipe-casing annulus is then calculated as follows:

$${μ}_{f} = K {γ}^{n - 1} \qquad ( 12 )$$

where γ represents the shear rate, s⁻¹; K represents the consistency coefficient; n represents the flow index; R_{w} represents a casing radius, m; r_{c} represents a washpipe radius, m; dew represents an equivalent diameter of the washpipe-casing annulus, m; u_{cw} represents an average pipe flow velocity in the washpipe-casing annulus, m/s; t represents a temperature, ° C.; p represents a formation pressure, MPa; Γ represents the nitrogen foam quality, %; and μ represents the apparent viscosity of the nitrogen foam fluid, Pa·s.

By following the methods described in 1)-5) of the step S2, the apparent density and apparent viscosity of the nitrogen foam fluid in the washpipe-screen annulus under the downhole temperature and pressure conditions can be rapidly calculated based on the gas-liquid ratio and the foaming agent concentration.
S3: Optimized method for designing construction parameters including a sand ratio and pumping rate for the nitrogen foam-carried gravel packing in the horizontal wells.

Based on experimental and numerical simulation results, as well as the density and apparent viscosity of the nitrogen foam fluid, this disclosure employs a least squares fitting method to establish rapid calculation methods for the pumping rate and the sand ratio.

$${Q}_{t} = 0 \text{.5966} \cdot {( 0.001667 {ρ}_{f} )}^{- 2.9316} \cdot {( 0.041 {μ}_{f} )}^{0.7133} \qquad ( 13 )$$

where Qₜ represents a recommended downhole pumping rate for the nitrogen foam-carried gravel packing in the horizontal wells, m³/min.

$${S}_{g} = 4.1 \; 75 \cdot {( 0. 00 \; 1637 {ρ}_{f} )}^{- 2.637} \cdot {( 0.042 {μ}_{f} )}^{0.6983} \qquad ( 14 )$$

where S_{g} represents a recommended sand ratio for the nitrogen foam-carried gravel packing in the horizontal wells, %.

To facilitate field application and implementation, a quick selection table for pumping rate and sand ratio parameters is further provided below, enabling rapid optimization design of the pumping rate and sand ratio parameters. (Note: the parameters can be selected when any single condition in the same row is satisfied, and the relationship between the indicators follows an “OR” logic.)

TABLE 5
Quick Selection of Carrier Fluid Pumping
Rate and Sand Ratio Parameters

| | Apparent viscosity | Recommended | |
|---|---|---|---|
| Density of the | of the nitrogen | downhole | Recommended |
| nitrogen foam | foam fluid | pumping rate | sand ratio |
| fluid ρ_{f}/(kg/m³) | μ_{f}/(mPa · s) | Qₜ/(m³/min) | S_{g}/% |
| >565 kg/m³ | >15 mPa · s | 0.5 | 5 |
| 480-565 kg/m³ | 12.5-15 mPa · s | 0.65 | 5.5 |
| 390-480 kg/m³ | 10-12.5 mPa · s | 0.8 | 6.0 |
| 300-390 kg/m³ | 5-10 mPa · s | 1.25 | 7 |
| <300 kg/m³ | <5 mPa · s | 1.5 | 8.5 |

During construction, the total screen-casing annulus volume is calculated based on the downhole pumping rate Qₜ and the recommended sand ratio S_{g} determined according to the method disclosed herein; then, the surface nitrogen volume Vₗ is calculated based on the nitrogen volume V_{g} under the downhole temperature and pressure conditions:

Under the ideal gas assumption, gas density changes correlate directly with volume compression ratios. For real gases, compression may lead to non-ideal behaviors, particularly under high-pressure conditions, possibly causing deviations from the ideal gas law. This necessitates introducing a compressibility factor Z for correction. Combining the ideal gas equation of state with the downhole and surface temperature and pressure conditions yields the following:

$$\frac{{V}_{l}}{{V}_{g}} = \frac{{P}_{g} {Z}_{l} {T}_{l}}{{Z}_{g} {T}_{g} {P}_{l}} \qquad ( 15 )$$

where Pₗ represents a surface pressure, MPa; Vₗ represents the surface nitrogen volume, m³; Tₗ represents a surface temperature, K; Zₗ represents a surface compressibility factor; P_{g} represents a downhole pressure, MPa; V_{g} represents the nitrogen volume under the downhole temperature and pressure conditions, m³; T_{g} represents a downhole temperature, K; and Z_{g} represents a downhole compressibility factor. The compressibility factor can be determined by: calculating the ratios of downhole temperature/pressure to nitrogen's critical temperature (126.2 K)/critical pressure (3.39 MPa), and then referring to the standard nitrogen compressibility factor chart; or directly referring to FIG. 1 to obtain the nitrogen compressibility factors Z under different temperature and pressure conditions, thereby deriving the corresponding surface compressibility factor Zi and downhole compressibility factor Z_{g}.

### Beneficial Effects of this Disclosure

(1) This disclosure addresses the current lack of an optimized method for designing the gas-liquid ratio and the foaming agent concentration and an optimized method for designing construction parameters in nitrogen foam-carried gravel packing in horizontal wells within unconsolidated sandstone reservoirs prone to sand production, and provides an optimized method for designing the nitrogen foam gas-liquid ratio and the foaming agent concentration for nitrogen foam-carried gravel packing in horizontal wells using simple physical parameters of reservoirs and wellbore parameters. The method covers key characteristic parameters relevant to oilfield operations, considers all critical factors holistically, and features simple and practical calculation procedures.
(2) This disclosure proposes a rapid calculation method for physical parameters of the carrier fluid based on reservoir temperature and pressure conditions, along with a simplified and efficient optimized method for designing construction parameters of nitrogen foam-carried gravel packing in horizontal wells. By providing a clear calculation and optimization procedure with a straightforward and easily implementable method, this disclosure offers an operational solution for rapid decision-making in sand control operations using nitrogen foam-carried gravel packing in high-loss horizontal wells within unconsolidated sandstone reservoirs, thereby ensuring scientific and rational implementation of nitrogen foam-carried gravel packing technology in horizontal wells within unconsolidated sandstone reservoirs, and enhancing both sand control efficiency and exploitation performance.

### BRIEF DESCRIPTION OF THE DRAWINGS

FIG. 1 shows nitrogen compressibility factors under different temperature and

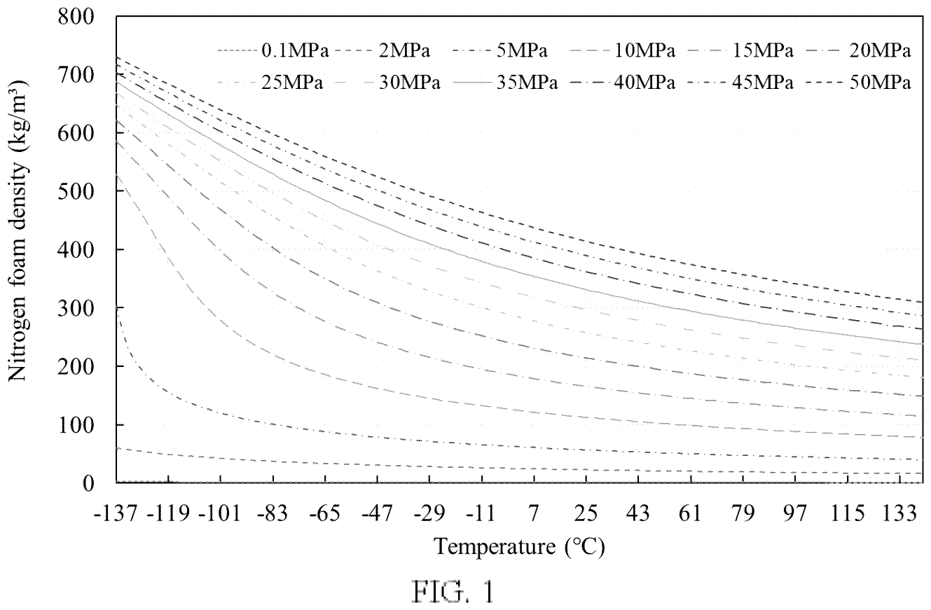

pressure conditions;

FIG. 2 shows nitrogen densities under different temperature and pressure conditions;

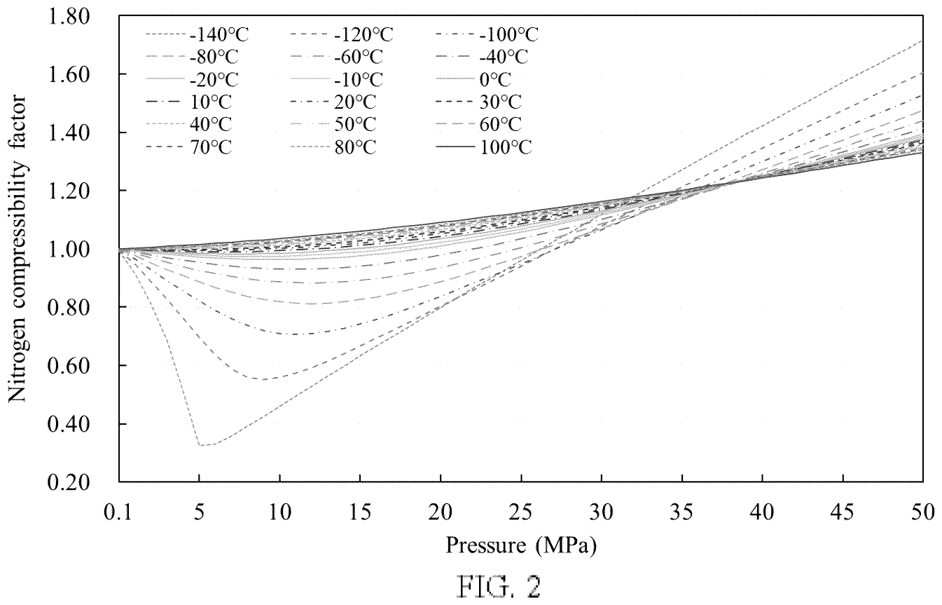

FIG. 3 shows a depth trajectory of Well P3; and

FIG. 4 shows packing effect simulation results of Well P3.

### DETAILED DESCRIPTION OF THE EMBODIMENTS

### Embodiment

The method for designing construction parameters of nitrogen foam-carried gravel packing in high-loss horizontal wells according to this disclosure was applied to Well P3, a horizontal well located in a high-loss production zone of Shengli Oilfield. Using the basic data shown in Table 6, the construction parameters for nitrogen foam-carried gravel packing in the horizontal well were designed.

TABLE 6
Basic Parameters of Well P3

| | | | |
|---|---|---|---|
| Original reservoir | 15 | Reservoir shale | 0.15 |
| pressure P_{f0}, MPa | | content Vₛₕ | |
| Current reservoir | 12 | Conventional carrier | 1000 |
| pressure P_{f}, MPa | | fluid density ρᵣ, | |
| | | kg/m³ | |
| Vertical depth of the | 1400 | Conventional carrier | 0.68 |
| horizontal well h, m | | fluid flow velocity vᵣ, | |
| | | m/s | |
| Original reservoir | 1.2 | Length of a | 600 |
| permeability K₀, D | | horizontal well | |
| | | section L, m | |
| Sand production | 27.8 | Washpipe diameter, | 0.07 |
| volume V_{c}, m³ | | m | |
| Formation porosity φ | 0.34 | Screen tube | 0.12 |
| | | diameter, m | |
| Conventional carrier | 1 | Casing diameter, m | 0.19 |
| fluid viscosity μᵣ, | | | |
| mPa · s | | | |
| Length of the well | 150 | Reservoir | 60 |
| section with fluid loss | | temperature, ° C. | |
| Lₕₗₛ | | | |
| Inclination angle of the | 86 | Production zone | 12 |
| horizontal well θ, ° | | thickness, m | |
| Type of packing gravel | Quartz sand | Particle size, mm | 0.4-0.8 |

Using the aforementioned basic data and following the method described in the step S1 of this disclosure, the optimal gas-liquid ratio and foaming agent concentration for nitrogen foam-carried gravel packing under the geological and well conditions of this horizontal well were calculated. The calculation results are listed in Table 7 below.

TABLE 7
Calculation Results of Nitrogen Foam Gas-Liquid
Ratio and Foaming Agent Concentration

| | |
|---|---|
| Current reservoir permeability K, D | 1.298 |
| Wellbore construction pressure P_{c}, MPa | 0.0094 |
| Sand production volume in the well Vᵣ, m³ | 339.12 |
| Apparent diameter of the washpipe-casing | 0.12 |
| annulus d_{cw}, m | |
| Screen-casing ratio R_{sw} | 0.63 |
| Washpipe-screen ratio R_{cs} | 0.58 |
| Reservoir fluid loss rate Rₗ | 0.356 |
| Packing safety index Fₛ | 0.8262 |
| Loss degree | Severe loss |
| Premature sand bridging risk | Medium risk |
| Gas-liquid ratio G_{wr} | Calculated design |
| | value 1.7734 |
| | 1.75 recommended |
| | according to Table 1 |
| Foaming agent concentration C_{f}, % | Calculated design |
| (calculated based on quartz sand) | value 1.329% |
| | 1.35% recommended |
| | according to Table 1 |

Based on the optimal gas-liquid ratio of 1.75 and foaming agent concentration of 1.35%, the apparent density and apparent viscosity of nitrogen foam in the washpipe-screen annulus under the downhole temperature and pressure conditions were calculated using the method described in the step S2 of this disclosure. The calculation results are listed in the table below.

TABLE 8
Calculation Results of Rheological Parameters of Nitrogen Foam

| | |
|---|---|
| Nitrogen density under the downhole | 131.100 |
| temperature and pressure conditions ρ_{g}, | |
| kg/m³ | |
| Nitrogen foam quality Γ, % | 63.600 |
| Density of the nitrogen foam fluid ρ_{f}, | 447.316 |
| kg/m³ | |
| Average pipe flow velocity in the | 0.680 |
| washpipe-casing annulus μ_{cw}, m/s | |
| Shear rate γ, s⁻¹ | 28.149 |
| Consistency coefficient K | 0.0468 |
| Flow index n | 0.518 |
| Apparent viscosity of the nitrogen foam | 9.357 |
| fluid μ_{f}, mPa · s | |

Based on the calculated density 447.316 kg/m³ and apparent viscosity 9.357 mPa·s of the nitrogen foam fluid, the pumping rate and sand ratio were rapidly calculated using the method described in the step S3 of this disclosure. The calculation results are listed in Table 9 below.

TABLE 9
Design Results of Construction Parameters for Nitrogen
Foam-Carried Gravel Packing in the Horizontal Well

| | |
|---|---|
| Recommended downhole | Calculated design value 0.7337 |
| nitrogen foam pumping rate Qₜ, | 0.8 recommended according to Table 5 |
| m³/min | |
| Recommended sand ratio S_{g}, % | Calculated design value 5.12 |
| | 5.5 recommended according to Table 5 |

By calculating the total screen-casing annulus volume (i.e., packing sand volume) of 10.221 m³, with a downhole nitrogen foam pumping rate of 0.8 m³/min and sand ratio of 5.5%, the total packing duration was determined to be 184.852 minutes, thereby enabling calculation of surface injection volumes and rates for nitrogen and liquid during construction.

TABLE 10
Surface Injection Volumes and Rates of
Nitrogen and Liquid during Construction

| | |
|---|---|
| Downhole pressure P_{g}, MPa | 12 |
| Downhole compressibility factor Z_{g} | 1.03 |
| Downhole temperature T_{g}, K | 333.15 (60° C.) |
| Nitrogen volume under the downhole | 94.106 |
| temperature and pressure conditions V_{g}, m³ | |
| Surface pressure Pₗ, MPa | 0.101 |
| Surface compressibility factor Zₗ | 1.00 |
| Surface nitrogen volume Vₗ, m³ | 9714.825 |
| Nitrogen injection rate, m³/min | 52.55 |
| Surface temperature Tₗ, K | 298.15 (25° C.) |
| Liquid volume Vₜ, m³ | 53.77 |
| Liquid injection rate, m³/min | 0.291 |

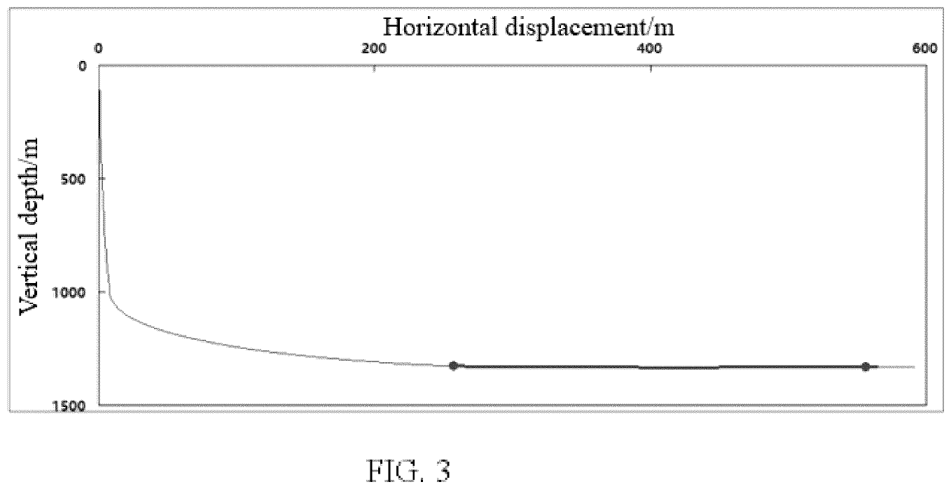

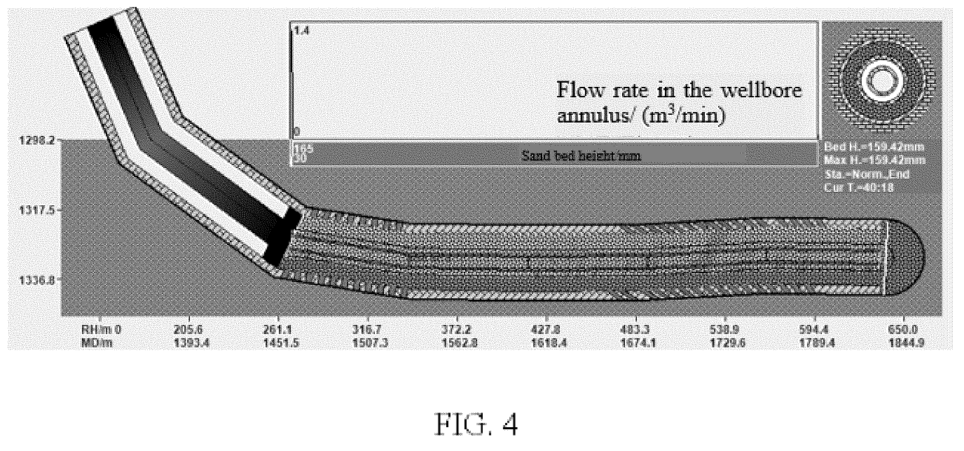

Well P3 was subjected to field horizontal gravel packing using the optimized construction parameters of nitrogen foam-carried gravel packing designed by this method. FIG. 3 shows a depth trajectory of Well P3, while FIG. 4 shows packing effect simulation results of Well P3. Field implementation at Well P3 achieved a verified packing efficiency of 100%, with good final packing effect.

What is claimed is:

1. A method for designing construction parameters of nitrogen foam-carried gravel packing in high-loss horizontal wells, comprising the following steps:
S1: determining a nitrogen foam gas-liquid ratio G_{wr} and a foaming agent concentration C_{f} for the nitrogen foam-carried gravel packing in the horizontal wells using a reservoir fluid loss rate Rₗ and a packing safety index Fₛ;
wherein the gas-liquid ratio G_{wr} is calculated by the following formula:
$${G}_{wr} = 1.9 \; 37 \cdot {R}_{l}^{0.135} \cdot {F}_{s}^{- 0.081} \cdot {T}^{0.005} ; \qquad ( 1 )$$
the foaming agent concentration Cfis calculated by the following formula:
$$\{ \begin{matrix}{C}_{f} = 1.5 \; 40 \cdot {R}_{1}^{0.228} \cdot {F}_{S}^{0.096} \cdot {T}^{0.012} ( quartz sand ) \\ {C}_{f} = 1.3 \; 69 \cdot {R}_{1}^{0.347} \cdot {F}_{S}^{0.099} \cdot {T}^{0.011} ( ceramic proppant )\end{matrix} , \qquad ( 5 )$$
wherein T represents a reservoir temperature, ° C.;
alternatively, the gas-liquid ratio G_{wr} and the foaming agent concentration C_{f} may be rapidly selected according to the following conditions:
(1) when any two of the following conditions are met: 0.1<Rₗ≤0.2, 0.9<Fₛ≤1.2, and 55° C.<T≤60° C., G_{wr}=1.5; if quartz sand is used as a packing material, C_{f}=1.25%; if ceramic proppants are used as the packing material, C_{f}=1.0%;
(2) when any two of the following conditions are met: 0.2<Rₗ≤0.35, 0.4<Fₛ≤0.9, and 60° C.<T≤65° C., G_{wr}=1.75; if the quartz sand is used as the packing material, C_{f}=1.35%; if the ceramic proppants are used as the packing material, C_{f}=1.25%;
(3) when any two of the following conditions are met: 0.35<Rₗ≤0.45, 0.1<Fₛ≤0.4, and 65° C.<T≤70° C., G_{wr}=2; if the quartz sand is used as the packing material, C_{f}=1.5%; if the ceramic proppants are used as the packing material, C_{f}=1.35%;
(4) when any two of the following conditions are met: 0.45<Rₗ, Fₛ<0.1, and T>70° C., G_{wr}=2.25; if the quartz sand is used as the packing material, C_{f}=1.75%; if the ceramic proppants are used as the packing material, C_{f}=1.5%;
wherein Rₗ represents the reservoir fluid loss rate; Fₛ represents the packing safety index; and T represents the reservoir temperature, ° C.;
S2: calculating an apparent density ρ_{f} and apparent viscosity μ_{f} of a nitrogen foam fluid in a washpipe-screen annulus under downhole temperature and pressure conditions; and
S3: calculating a pumping rate and sand ratio for construction operations based on the apparent density ρ_{f} and apparent viscosity μ_{f} of the nitrogen foam fluid under the downhole temperature and pressure conditions.

2. The method for designing the construction parameters of claim 1, wherein in the step S1, the reservoir fluid loss rate Ry is calculated by the following formula:
$${R}_{l} = \frac{K}{{K}_{0}} \cdot \sqrt{φ \cdot {V}_{sh}} \cdot \frac{{P}_{f 0}}{{P}_{f}} \cdot \frac{{P}_{c} + {ρ}_{r} gh / 1000}{{P}_{f}} \qquad ( 2 )$$
$$wherein$$
$$\{ \begin{matrix}K & = {K}_{0} \cdot ( 1 + \frac{{V}_{c}}{{V}_{r}} ) \\ R {e}_{r} & = \frac{{v}_{r} {ρ}_{r} {d}_{cw}}{{μ}_{τ}} \\ {P}_{c} & = \frac{64}{R {e}_{r}} \cdot \frac{L}{{d}_{cw}} \cdot \frac{{ρ}_{r} {v}_{r}^{2}}{2}\end{matrix} \qquad ( 3 )$$
wherein Rₗ represents the reservoir fluid loss rate; P_{f0} represents an original reservoir pressure, MPa; P_{f} represents a current reservoir pressure, MPa; P_{c} represents a wellbore construction pressure, MPa; h represents a vertical depth of a horizontal well, m; K₀ represents an original reservoir permeability, D; K represents a current reservoir permeability, D; V_{c} represents a sand production volume obtained through field detection, m³; Vᵣ represents a formation volume within a 3-m radius around a production zone, m³; φ represents a formation porosity, %; Vₛₕ represents a reservoir shale content, %; ρᵣ represents a conventional carrier fluid density, kg/m³; vᵣ represents a conventional carrier fluid flow velocity, m/s; L represents a length of a horizontal well section, m; Reᵣ represents a Reynolds number for the horizontal well section; dew represents an apparent diameter of a washpipe-casing annulus, m; μᵣ represents a conventional carrier fluid viscosity, Pa·s; and g is equal to 9.8 N/kg;
the packing safety index Fₛ is calculated by the following formula:
$${F}_{s} = 0.25 \times ln ( \frac{L}{{R}_{l} {L}_{hls}} ) + 0.5 \times \frac{{R}_{cs}}{{R}_{w}} - 0.25 \times \frac{θ}{90} \qquad ( 4 )$$
wherein Lₕₗₛ represents a length of a well section with fluid loss, m; R_{sw} represents a screen-casing ratio; R_{cs} represents a washpipe-screen ratio; and θ represents an inclination angle of the horizontal well, °.

3. The method for designing the construction parameters of claim 1, wherein in the step S1, the foaming agent is sodium dodecyl benzene sulfonate.

4. The method for designing the construction parameters of claim 1, wherein in the step S2, the density of the nitrogen foam fluid ρ_{f} is calculated by the following formula:
$${ρ}_{f} = ( 1 - Γ ) {ρ}_{l} + Γ {ρ}_{9} \qquad ( 7 )$$
wherein ρ_{f} represents the density of the nitrogen foam fluid, kg/m³; ρₗ represents a liquid density, kg/m³; ρ_{g} represents a nitrogen density under the downhole temperature and pressure conditions, kg/m³; and Γ represents nitrogen foam quality, %.

5. The method for designing the construction parameters of claim 4, wherein in the step S2, the nitrogen foam quality Γ is calculated by the following formula:
$$Γ = 100 \frac{{G}_{ur} - 1}{{G}_{ur}} . \qquad ( 6 )$$

6. The method for designing the construction parameters of claim 1, wherein in the step S2, the apparent viscosity μ_{f} of the nitrogen foam fluid is calculated by the following formula:
$${μ}_{f} = K {γ}^{n - 1} \qquad ( 12 )$$
wherein γ represents a shear rate, s⁻¹; K represents a consistency coefficient; and n represents a flow index;
wherein the shear rate γ is calculated by the following Formula (11):
$$γ = \frac{3 n + 1}{4 n} \cdot \frac{8 {u}_{cw}}{{d}_{cw}} {d}_{cw} = 4 \frac{π ( {R}_{w}^{2} - {r}_{c}^{2} )}{2 π ( {R}_{w} + {r}_{c} )} \qquad ( 11 )$$
K and n are calculated by the following Formula (10):
$$\{ \begin{matrix}K = \frac{6.692}{{c}_{f}} ( - 0.00 \; 0027 {Γ}^{2} + 0.00 \; 4166 Γ + - 0.136098 ) \cdot {e}^{( 0.1 \; 775 p - 0.0 \; 46 t )} \\ n = 1.57 ( - 0.00 \; 0028 {Γ}^{3} + 0.00 \; 6018 {Γ}^{2} + - 0.422598 Γ + 10.308523 ) {e}^{( - 0.04 p )} \cdot ( 0.3619 ln ( t )\end{matrix} . \qquad ( 10 )$$
wherein R_{w} represents a casing radius, m; r_{c} represents a washpipe radius, m; d_{cw} represents an equivalent diameter of the washpipe-casing annulus, m; u_{cw} represents an average pipe flow velocity in the washpipe-casing annulus, m/s; t represents a temperature, ° C.; p represents a formation pressure, MPa; and Γ represents the nitrogen foam quality, %.

7. The method for designing the construction parameters of claim 6, wherein the Formula (10) is obtained by conducting nitrogen foam rheology experiments under different temperature, pressure, and nitrogen foam quality conditions using a capillary rheometer, determining rheological parameters of a power-law fluid, namely the flow index n and the consistency coefficient K, for nitrogen foam under the different temperature and pressure conditions based on a relationship between a flow rate and a pressure drop during the experiments, performing normalization processing on the experiments to fit calculation formulas for the rheological parameters under the different conditions, and further simplifying the formulas.

8. The method for designing the construction parameters of claim 1, wherein in the step S3, based on the density ρ_{f} and apparent viscosity μ_{f} of the nitrogen foam fluid, a least squares fitting method is employed to establish rapid calculation methods for the pumping rate and the sand ratio:
$${Q}_{t} = 0.5 \; 966 \cdot {( 0. 00 \; 1667 {ρ}_{f} )}^{- 2.9316} \cdot {( 0.041 {μ}_{f} )}^{0.7133} \qquad ( 13 )$$
wherein Qₜ represents a recommended pumping rate for the nitrogen foam-carried gravel packing in the horizontal wells, m³/min;
$${S}_{g} = 4.1 \; 75 \cdot {( 0. 00 \; 1637 {ρ}_{f} )}^{- 2.637} \cdot {( 0.042 {μ}_{f} )}^{0.6983} \qquad ( 14 )$$
wherein S_{g} represents a recommended sand ratio for the nitrogen foam-carried gravel packing in the horizontal wells, %.

9. The method for designing the construction parameters of claim 1, wherein in the step S3, the pumping rate and the sand ratio are rapidly selected according to the following conditions:
(1) when either of the following conditions is met: ρ_{f}>565 kg/m³, and μ_{f}>15 mPa·s, Qₜ=0.5 m³/min, and S_{g}=5%;
(2) when either of the following conditions is met: 480<ρ_{f}≤565 kg/m³, and 12.5<μ_{f}≤15 mPa·s, Qₜ=0.65 m³/min, and S_{g}=5.5%;
(3) when either of the following conditions is met: 390<ρ_{f}≤480 kg/m³, and 10<μ_{f}≤12.5 mPa·s, Qₜ=0.8 m³/min, and S_{g}=6.0%;
(4) when either of the following conditions is met: 300≤ρ_{f}≤390 kg/m³, and 5<μ_{f}≤10 mPa·s, Qₜ=1.25 m³/min, and S_{g}=7.0%;
(5) when either of the following conditions is met: ρ_{f}<300 kg/m³, and μ_{f}<5 mPa·s, Qₜ=1.5 m³/min, and S_{g}=8.5%;
wherein ρ_{f} represents the density of the nitrogen foam fluid; μ_{f} represents the apparent viscosity of the nitrogen foam fluid; Qₜ represents the recommended pumping rate for the nitrogen foam-carried gravel packing in the horizontal wells; and S_{g} represents the sand ratio for the nitrogen foam-carried gravel packing in the horizontal wells.
